(19) United States
(12) Patent Application Publication
(10) Pub. No.: US 2012/0063870 A1
(43) Pub. Date: Mar. 15, 2012

(54) SYSTEM FOR INJECTING FASTENERS IN THE MANUFACTURE OF AIRCRAFT OR OTHER ASSEMBLIES

(75) Inventors: Benjamen D. Hempstead, Edmonds, WA (US); Jarrod A. Wallace, Seattle, WA (US)

(73) Assignee: Electroimpact, Inc., Mukilteo, WA (US)

(21) Appl. No.: 12/878,872

(22) Filed: Sep. 9, 2010

(51) Int. Cl. B65G 49/00

(52) U.S. Cl. 414/226.03; 414/222.01

(57) ABSTRACT

The injector assembly receives fasteners such as bolts used in the manufacture of composite aircraft wing structures, at a high speed from a supply thereof, such as a cartridge. The injector assembly includes a post assembly which includes a hollow post housing having a post mass and a mass stop pin positioned within the housing. The bolt moves through a feed tube assembly, a muzzle member and into a chamber portion of the injector assembly. A urethane contact member is positioned at a forward end of the mass. A source of compressed air moves the mass and the contact member into a position slightly past the rear end of the housing and into a chamber portion of the injector assembly. When the bolt contacts the contact member at high speed, the mass is moved back toward a base portion of the post assembly. The mass is sufficient to dissipate the kinetic energy of the moving bolt without damage thereto.

### TECHNICAL FIELD

This invention relates generally to the manufacture of large commercial aircraft or other large assemblies, and more particularly concerns a system for delivering fasteners, such as bolts, received from a fastener feed cartridge to a fastener insertion assembly which in turn moves the fastener into an aircraft panel or the like.

### BACKGROUND OF THE INVENTION

In the manufacture of large aircraft assemblies such as for instance a wing assembly, where stringers are fastened to wing skin panels, machines are used to install thousands of rivets and/or bolts in the fastening process for a typical assembly. The, rivets, the bolts or other fasteners are blown by compressed air from a feed cartridge to an injector system which receives the fasteners and then injects, i.e. delivers, them into a separate insertion assembly. To prevent damage to the fasteners during their travel through the injector system, as well as damage to the aircraft panels in which they are inserted, the fasteners travel at a relatively low speed of approximately 10-15 mph, even though the compressed air system could move the fasteners at a much higher speed. This relatively low travel speed of the fasteners ultimately limits the insertion rate of the fasteners into the aircraft panels. It would desirable to increase the speed of the fasteners through the injector system, in order to increase the overall rate of production of the aircraft, without causing damage to the fasteners when they are stopped at the end of the injector system and ready to be moved to the insertion assembly.

### SUMMARY OF THE INVENTION

Accordingly, the assembly is disclosed herein for receiving fasteners and positioning them for an insertion assembly in the manufacture of aircraft, or other large assemblies, comprising: a feed assembly for moving fasteners from a supply thereof; and an assembly for stopping a moving fastener from the feed assembly prior to the fastener being positioned for an insertion assembly which in turn inserts the fastener into an aircraft or other assembly member to be fastened, the stopping assembly including a hollow post member housing, a mass having a contact member at a rear end thereof for contact with the moving fastener, the mass positioned within and movable within the post member housing, the stopping assembly further including a chamber having an opening therethrough, positioned in front of the hollow post member housing and arranged such that the chamber opening is in registry with the contact member, wherein contact between a moving fastener from the feed assembly and the contact member moves the mass back into the housing, wherein the mass dissipates the kinetic energy of the fastener without damage thereto.

### BRIEF DESCRIPTION OF THE DRAWINGS

FIGS. 1 and 2 are a simplified view of the bolt injector system and insertion assembly, and relative to an aircraft panel (FIG. 2).

FIG. 3 is a perspective view of the bolt injector system.

FIG. 4 is a perspective view showing a feed tube shifter assembly with feed tubes attached.

FIG. 5 is a cross-section view showing a detailed view of a muzzle portion of the bolt injection assembly with a bolt shown therein.

FIG. 6 is another perspective view showing the injector system of FIG. 1.

FIG. 7 is a cross-sectional view showing a bolt in both a chamber portion and a post assembly portion of the injector system.

FIG. 8 is a simplified cross-sectional view of the post assembly portion of the injector system.

FIG. 9 shows a damper mass shown in FIGS. 7 and 8 being moved by contact with a moving bolt.

FIG. 10 shows the post assembly pinching the bolt against a bolt stop pin.

FIG. 11 shows the bolt in feed fingers of the insertion assembly.

FIG. 12 shows the injector system retracting leaving the bolt in the feed fingers of the insertion assembly for insertion into an aircraft panel.

### BEST MODE FOR CARRYING OUT THE INVENTION

The present apparatus is designed to receive a fastener, such as a bolt, from a conventional fastener feed cartridge assembly, moved to the apparatus by compressed air at a relatively high speed. The apparatus, referred to as a fastener injector system, stops the bolt quickly at a position adjacent a bolt insertion assembly without damage to the bolt and then positions the bolt so that it can be grasped by the bolt insertion assembly for insertion into a panel of an aircraft, typically a large commercial aircraft or other large assembly. The terms bolt and fasteners are used interchangeably herein. The term fastener is intended to be broad, covering a variety of elements, including rivets, which are used in fastening operations for large scale assemblies such as aircraft wings. Further, while the invention is described in the context of aircraft, other large scale assemblies are suitable for use of the injector system.

The fastener feed assembly and the fastener insertion assembly described briefly herein may take various configurations, and form no part of the present invention. The fasteners used in the present insertion assembly can have a variety of configurations and sizes. Typically, however, the fastener will be bolts which are particularly configured and sized for use in composite aircraft panels. As such, they can be significantly more complex and expensive than conventional lock bolts used in other fastening operations, such as for previous metal wing assemblies. The bolts used for composites can cost up to $100 per piece. Further, the bolts are easily damaged, and hence must be handled and moved from the feed cartridge to the insertion assembly carefully. A damaged bolt, besides the loss of the bolt itself, if actually inserted into a wing panel, must be removed, creating significant additional cost in time. Damaged bolts can also damage the aircraft parts upon insertion, requiring expensive repair to the aircraft parts.

For efficiency of manufacture, however, it is desirable to move the bolts as quickly as possible from the feed cartridge to the position where they can be grasped by the insertion assembly. Heretofore, the rate of speed of the bolts to and through the injector system, in order to prevent damage, results in an insertion rate of 5.5 bolts per minute which includes the time for other necessary machine operations, including moving the overall system to each location in succession for the fasteners, drilling the hole in the wing and swaging the installed bolt. The present arrangement permits a faster moving bolt to and through the injector system, with a resulting insertion rate of up to 8 bolts per minute, with the other machine operations remaining the same.

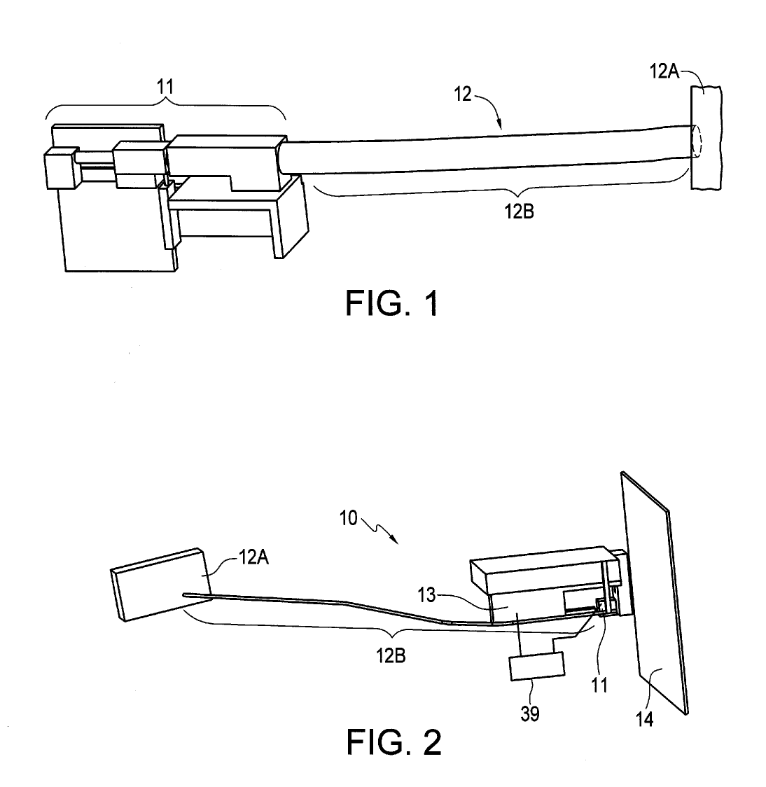

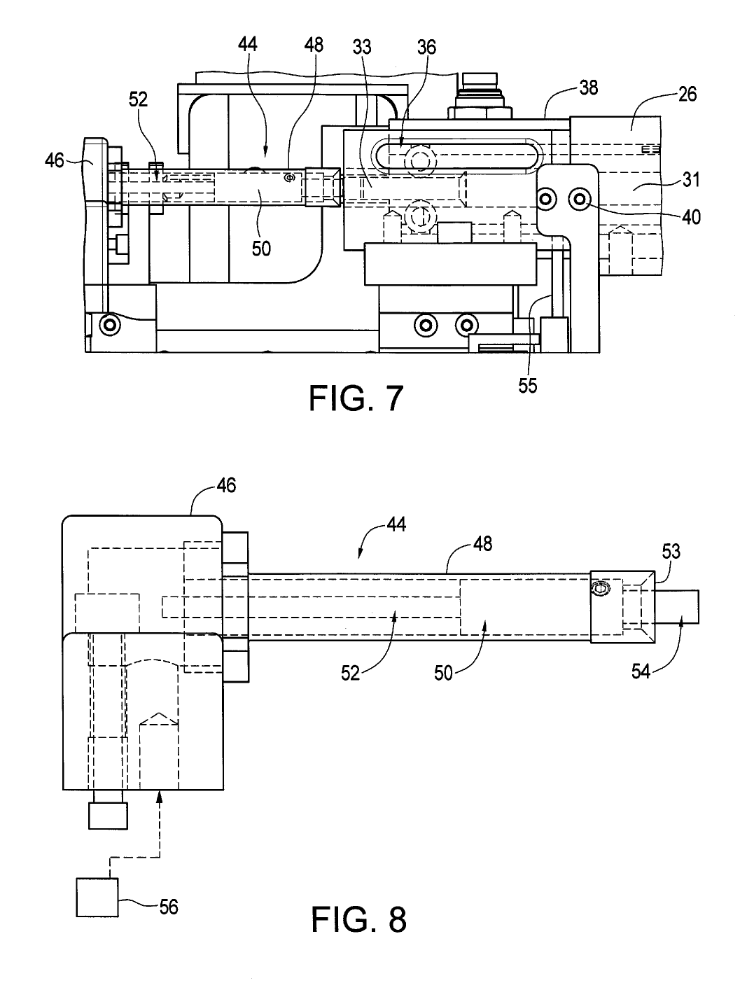

FIGS. 1 and 2 show in very general, representational form for illustration a complete assembly system 10 which includes an injector system and an insertion assembly relative to an aircraft panel. FIG. 1 shows the cartridge feed assembly 12 and the injector assembly 11, while FIG. 2 shows the more complete assembly system. The injector system 11 is the subject of this application. The cartridge feed assembly 12 includes a fastener cartridge 12A. FIG. 2 also shows an insertion assembly at 13 and an aircraft panel at 14. The injector assembly 11 is shown in more detail in FIG. 7.

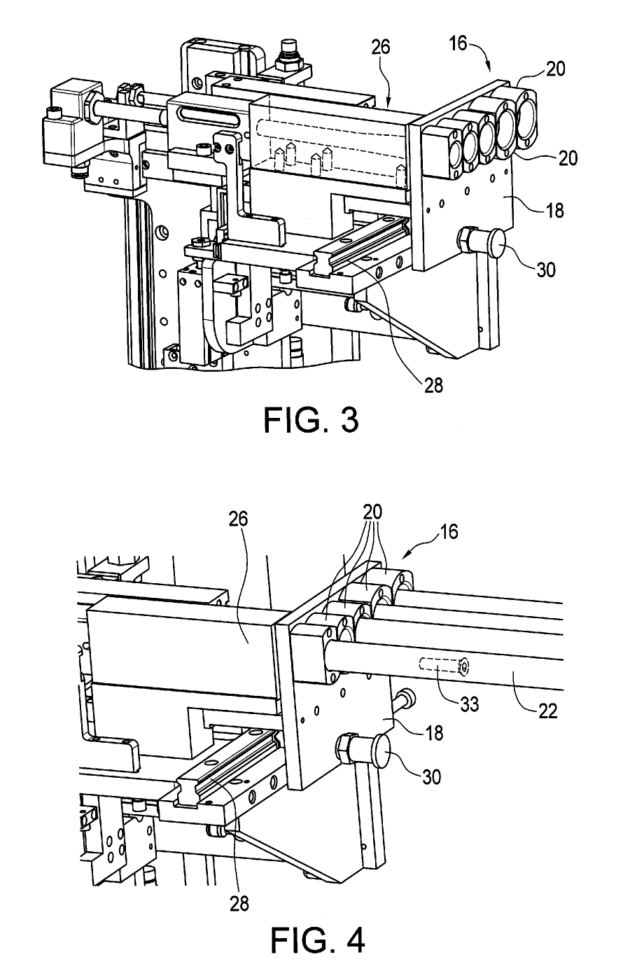

Typically, but not necessarily, the fasteners which are used in the system are ¼-inch to ⅝-inch diameter bolts, typically lock bolts or slave bolts, but other fasteners could be used as well. For the particular use described herein for composite panels, the bolts are 63 mm long, although again this length can be varied. In the assembly system 10 generally, the lock bolts are stored in a cartridge container 12A from which they are moved at high speeds, typically 40-70 mph, through a feed tube, with an air flow rate typically of 35-50 CFM. The bolts are moved down a selected feed line 12B to a feed tube shifter portion of the injector system, shown generally at 16 in FIG. 3. The feed tube shifter shown generally in FIG. 3 is one of the primary subassemblies of the injector system 11. The feed tube shifter in the embodiment shown comprises a plate 18 to which a plurality of connecting members 20-20 are mounted side-by-side. Each connecting member 20 receives a feed tube 22 (FIG. 4) with each connecting member 20 and associated feed tube 22 sized to accommodate a different size (diameter) bolt.

Plate 18 has a plurality of holes therethrough which are in registry with the individual connecting elements 20 and associated feed tubes 22. The feed tube shifter 16 is mounted on a rail assembly 28. The feed tube shifter subassembly allows the particular feed tube feeding the injector system to be changed quickly and conveniently. In order to change the feed tube for the injector system, such as to accommodate a different size bolt, an operator pulls on pin 30, and slides the feed tube shifter 16 along rail assembly 28 to the point where the correct size feed tube and associated connecting element for the bolt to be inserted into the wing is in registry with an opening through plate 18 into a muzzle 26, which is the next part of the injector system. Several proximity switches (not shown) form part of the feed tube shifter 16 to confirm the correct lateral position of the feed tube shifter for a particular size bolt, so that the bolt moving through the feed line and then through the associated connecting element will move through the opening in the plate into the muzzle. The feed tube containing the moving bolt, the associated connecting element and the associated opening in plate 18, must be aligned with opening 31 in the muzzle.

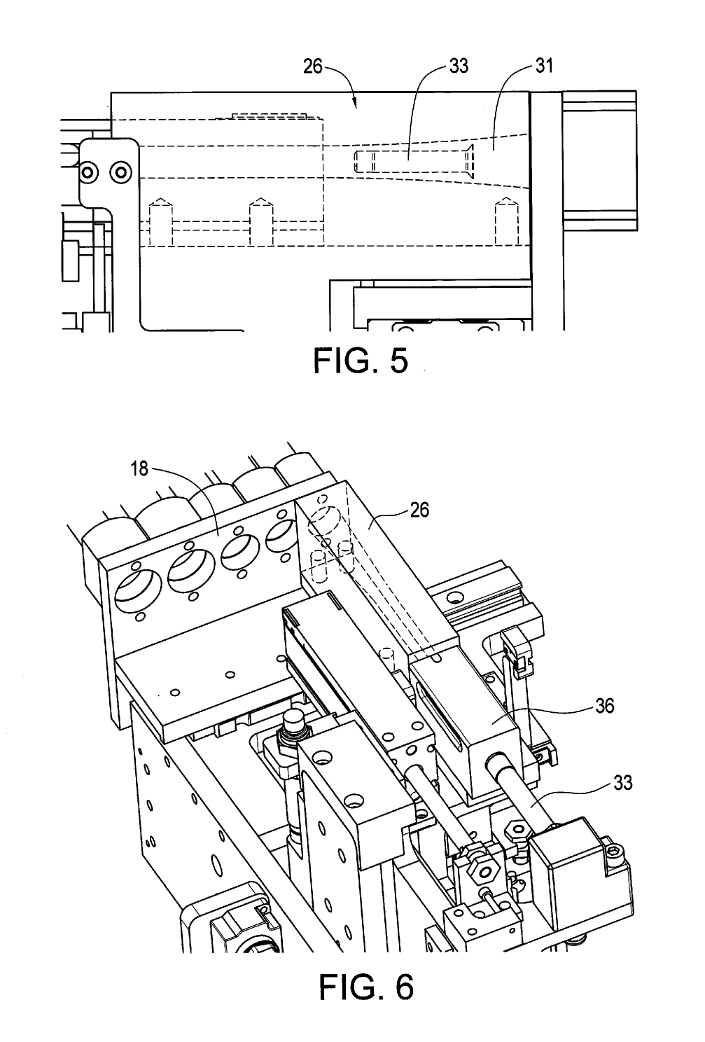

The muzzle 26, shown in FIGS. 3-5, includes opening 31 which extends longitudinally therethrough, with the inside diameter of the opening 31 tapering down from the internal diameter of the particular feed tube and the opening in plate 18, which are in registry with the muzzle opening 31, to a diameter approximately 0.010 inches larger than the bolt 33 head diameter in the feed tube. The bolt 33 is shown in the muzzle in FIG. 5. The bolt is thus constrained in any side-to-side movement prior to reaching the next subassembly, chamber 36, shown in FIGS. 6 and 7. The taper, while helpful in the movement of the bolt, is not necessary.

The chamber subassembly 36 receives the bolt from the muzzle 26. The chamber subassembly in the embodiment shown is a block of polyurethane and includes an opening 38 therethrough which is in registry with the exit of muzzle opening 31. The chamber subassembly 36 also includes a fiber optic beam assembly 40 which generates an optical beam extending across the path of the moving bolt. The moving bolt traveling at high speed by compressed air will break the optical beam, resulting in a signal being sent to the assembly controller 39 (FIG. 2), which is a conventional microcontroller, indicating that a bolt has entered chamber 36 from muzzle 26. FIGS. 6 and 7 show the position of a bolt 33 in the chamber after it passed the fiber optic assembly 40. The chamber 36 is mounted on linear rails 45 so that it can move back and forth longitudinally, toward and away from muzzle 26 and the following post subassembly. At the rear end of the chamber, following the muzzle, is a bolt stop pin 55 which elevates after the bolt has passed, to stop bolts from rebounding back into the muzzle. The stop pin 55 is not connected to the chamber, however, so that the chamber is free to move longitudinally relative to the post assembly without moving the bolt. Following the chamber subassembly is a post subassembly 44, which is a major part of the injector assembly, shown most clearly in FIG. 8. The post subassembly 44 includes a post base 46 member and an elongated hollow post housing 48 which extends outwardly from the post base 46 toward the chamber 36. Positioned within post housing 48 is a mass 50 and a mass stop pin 52 which extends toward post base 46. In the embodiment shown, the mass is tungsten, but could be other material capable of providing sufficient mass to stop the movement of the bolt after impact within the allowed distance.

Positioned on a forward end 53 of mass 50 is a urethane nub member 54. Attached to and communicating with the post base and the hollow post housing is a compressed air supply 56. The hollow post housing 48, including mass 50 and the forward nub 54 therein, are all aligned with the bolt moving through chamber 36 (FIG. 7). The mass and the nub are positioned such that in the rest position, the nub typically extends a distance of approximately 6-50 mm beyond a forward end 53 of the post housing, depending on the particular application, due to compressed air action. The diameter of the mass is approximately 0.005 inches smaller than the internal diameter of the post housing.

The post assembly is responsible for stopping the bolt which is moving at a high rate of speed through the chamber, without damage to the bolt. The mass 50 and the air pressure from source 56 accomplishes the stopping of the bolt. The mass is calculated for the largest size bolt for a particular bolt diameter. The entire post assembly is interchangeable for each different bolt diameter. The weight of the mass is calculated with the following formula:

$${V}_{1 f} = \frac{( {C}_{R} + 1 ) {M}_{2} {V}_{2} + {V}_{1} ( {M}_{1} - {C}_{R} {M}_{2} )}{{M}_{1} + {M}_{2}}$$

Where M₁ equals the mass of the bolt and M₂ is equal to the weight of the mass 50, V/₁ is equal to the velocity of the bolt before impact, V₂ is equal to the velocity of the mass before impact, V_{1f} is equal to the final velocity of the bolt after impact and Cᵣ is equal to the coefficient of restitution. The recoil of the mass 50 after impact of the speeding bolt against the nub of the mass operates to quickly stop the bolt, the bolt being positioned to be then grasped by the insertion assembly.

The sequence of operation for the above-identified injection assembly is as follows:

A fastener, such as a bolt, is blown through a feed tube from a bolt cartridge at a high velocity, typically between 40-70 mph depending on the particular bolt size. The air flow in the feed to the feed tube shifter 16 is between 35-50 CFM. The bolt will move through its size-associated feed tube, through an associated opening in plate 18, and then into muzzle 26. The tapered longitudinal opening through muzzle 26 constrains side-to-side movement of the bolt before it enters chamber subassembly 36. Before the moving bolt enters the chamber 36, it breaks a fiber optic beam which indicates that the bolt has entered the chamber 36. The bolt enters the chamber at a high rate of speed, and contacts nub 54 on the end of mass 50. In its rest position, the nub extends into the chamber opening approximately 0.25 inches. When the bolt hits the nub, mass 50 is pushed back along the hollow post housing, pushing the mass stop pin 52 back as well. This arrangement increases the duration of the impact event, and results in the dissipation of the kinetic energy of the bolt. The bolt comes to a stop (without further forward movement), without damage. Next, a bolt stop pin 55 extends (elevates), at the rear end of the chamber 36 adjacent muzzle 26, across chamber opening 38. The stop pin prevents the bolt from rebounding back into the muzzle following contact with nub 54.

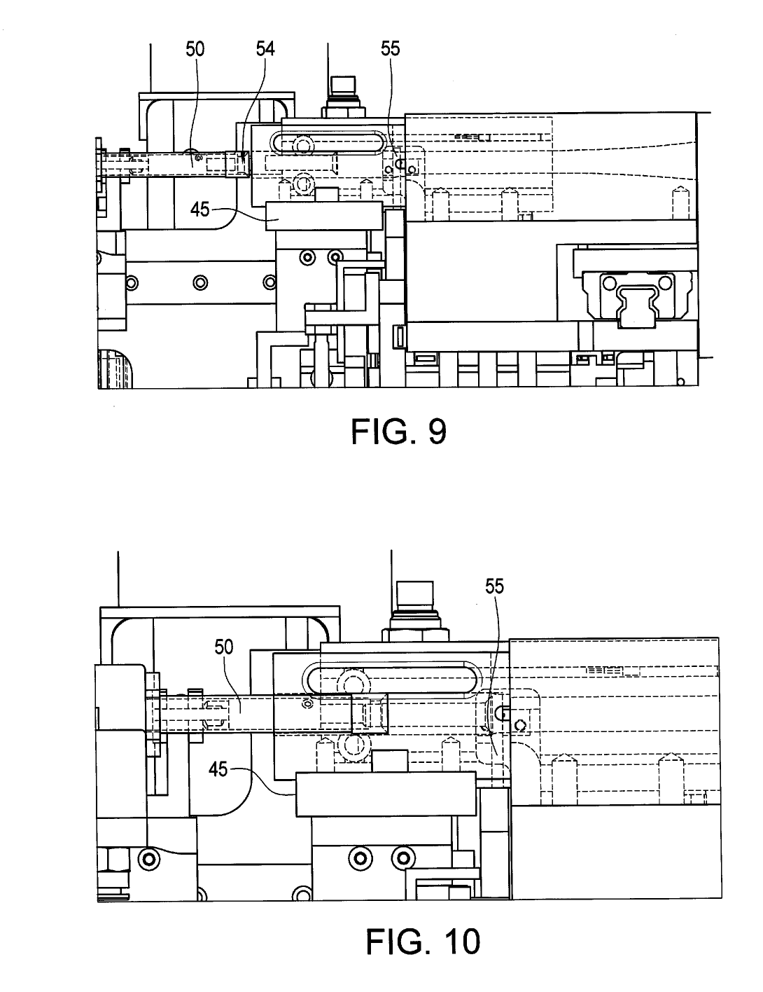

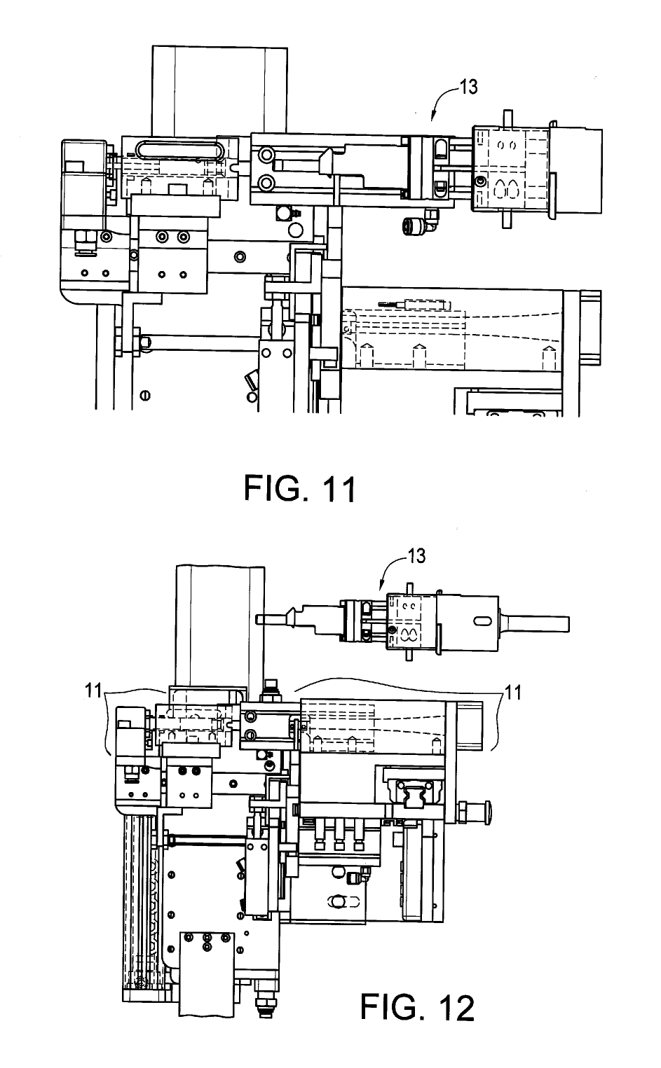

The entire post subassembly 44 then moves on a linear rail 58 toward the chamber, pressing the head of the bolt against the bolt stop pin 55, in effect pinching the bolt against the stop pin 55 in chamber 36. The chamber 36 then moves (extends) toward the post assembly, as shown in FIG. 9, on its linear rails 45, exposing the head of the bolt. The head remains pinched against the bolt stop pin by action of the post assembly. With the head and a part of the forward shank exposed, the insertion assembly 13 can grasp the bolt, as shown in FIG. 11. The insertion assembly, as indicated above, does not form a part of the present invention. Next in sequence, the post assembly, chamber 36 and the bolt stop pin all drop down, such that the bolt, held by the insertion assembly 13, is free of the injector system. The bolt insertion assembly is now free to place the bolt into a previously drilled opening in the aircraft panel for fastening.

From time to time, it may be necessary to purge the injection system, such as when the wrong size bolt is fed to the muzzle or two bolts are fed at once. In the purge cycle, the chamber subassembly is extended, and the feed tube compressed air clears all the bolts in the system.

Accordingly, a fastener injector system has been disclosed which is part of a manufacturing assembly for large aircraft or other large assemblies. The injector system is capable of allowing increased speed of the moving bolts in the feeding process without damage to the bolts, thereby resulting in an increase in the rate of insertion of bolts during fastening operations. The injector system includes a post subassembly, which includes a mass and a forward nub which absorbs the kinetic energy of the fast moving bolt from the bolt (or other fastener) feed supply without damage to the fastener.

Although a preferred embodiment has been disclosed for purposes of illustration, it should be understood that various changes and modifications and substitutions may be made in the embodiment without departing from the spirit of the invention as defined by the claims which follow:

What is claimed is:

1. An assembly for receiving fasteners and positioning them for an insertion assembly in the manufacture of aircraft, or other large assemblies, comprising:
a feed assembly for moving fasteners from a supply thereof; and
an assembly for stopping a moving fastener from the feed assembly prior to the fastener being positioned for an insertion assembly which in turn inserts the fastener into an aircraft or other assembly member to be fastened, the stopping assembly including a hollow post member housing, a mass having a contact member at a rear end thereof for contact with the moving fastener, the mass positioned within and movable within the post member housing, the stopping assembly further including a chamber having an opening therethrough, positioned in front of the hollow post member housing and arranged such that the chamber opening is in registry with the contact member, wherein contact between a moving fastener from the feed assembly and the contact member moves the mass back into the housing, wherein the mass dissipates the kinetic energy of the fastener without damage thereto.

2. The assembly of claim 1, including a source of compressed air which acts to position the mass and the contact member such that the contact member extends out of the rear end of the housing, the compressed air assisting in the stopping of the moving fastener.

3. The assembly of claim 1, including a mass stop pin positioned within the post member housing and connected to a rear end of the mass, wherein the mass stop pin limits movement of mass into the post assembly upon contact by the fastener.

4. The assembly of claim 1, including a fastener stop pin which is positioned across said opening through the chamber, preventing the fastener from rebounding back into and then out of the chamber at a rear end thereof.

5. The assembly of claim 1, wherein the fastener is a bolt.

6. The assembly of claim 1, wherein the contact member is a plastic member, sufficiently soft so that contact between the bolt and the plastic member will not damage the bolt.

7. The assembly of claim 1, wherein the bolt is moved through the chamber and against the contact member at a speed of between 50-70 miles per hour.

8. The assembly of claim 5, including a muzzle member having an opening longitudinally therethrough, the opening in the muzzle being in registry with the opening in the chamber, and wherein the opening in the muzzle assembly narrows in diameter from an entry portion to approximately 0.01 inches greater than a head portion of the bolt moving therethrough.

9. The assembly of claim 1, wherein the fastener is a bolt having adapted for fastening composite wing members of a commercial aircraft.

10. The assembly of claim 8, including a fiber optic beam assembly for generating a beam across the path of travel of the fastener between the muzzle member and the chamber.

11. The assembly of claim 1, including a feed tube shifter assembly which includes a plurality of feed tubes accommodating a plurality of different size bolts, the shifter assembly being moveable to bring into registry a feed tube sized for a particular size bolt and the opening in the muzzle member.

12. An assembly for receiving fasteners and positioning them for an insertion assembly in the manufacture of aircraft, or other large assemblies, comprising:
a feed assembly for moving fasteners from a supply thereof; and
an assembly for stopping a moving fastener from the feed assembly prior to the fastener being positioned for an insertion assembly which in turn inserts the fastener into an aircraft or other assembly member to be fastened, the stopping assembly including a hollow post member housing, a mass having a contact member at a rear end thereof for contact with the moving fastener, the mass positioned within and movable within the post member housing, wherein contact between a moving fastener from the feed assembly and the contact member moves the mass backwardly in the housing, wherein the mass is sufficient to dissipate the kinetic energy of the fastener without damage thereto.

13. The assembly of claim 12, including a source of compressed air connected to the hollow post member for assisting in the stopping of the moving fastener.

14. The assembly of claim 12, wherein the contact member is plastic.
